(19) United States
(12) Patent Application Publication
(10) Pub. No.: US 2025/0021771 A1
(43) Pub. Date: Jan. 16, 2025

(54) MULTI-LANGUAGE CONVERSION DEVICE AND MULTI-LANGUAGE CONVERSION METHOD

(71) Applicants: Digiwin Software Co., Ltd, Shanghai (CN); DATA SYSTEMS CONSULTING CO., LTD., New Taipei City (TW)

(72) Inventors: Zhi Zhang, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/489,019

(22) Filed: Oct. 18, 2023

(30) Foreign Application Priority Data
Jul. 13, 2023 (CN) 202310861234.4

(51) Int. Cl. G06F 40/58; G06F 16/958; G06F 40/186

(52) U.S. Cl. CPC G06F 40/58; G06F 16/958; G06F 40/186

(57) ABSTRACT

A multi-language conversion device and a multi-language conversion method are provided. The multi-language conversion device includes a storage device and a processor. The storage device is configured to store a multi-language template configuration. The processor is coupled to the storage device and configured to receive a request instruction. The processor obtains aggregated data corresponding to the request instruction according to the request instruction. The processor performs type matching on a calling type and the multi-language template configuration according to the calling type of the request instruction, so as to obtain a corresponding multi-language template. The processor performs multi-language conversion on the aggregated data according to the multi-language template to obtain converted data. The multi-language conversion device and the multi-language conversion method of the disclosure are adapted to automatically perform multi-language conversion according to the corresponding multi-language template.

### CROSS-REFERENCE TO RELATED APPLICATION

This application claims the priority benefit of China application serial no. 202310861234.4, filed on Jul. 13, 2023. The entirety of the above-mentioned patent application is hereby incorporated by reference herein and made a part of this specification.

### BACKGROUND

### Technical Field

The disclosure relates to a data processing technology and a language conversion technology, and particularly relates to a multi-language conversion device and a multi-language conversion method.

### Description of Related Art

In conventional page data display, when a field needs to be converted according to a language of a webpage, the conversion is usually performed for the language in the webpage, such as a language conversion function that comes with the webpage, or static converted data preset for the language. However, the existing methods cannot effectively convert language fields in dynamic data, or cannot effectively perform language conversion on the fields of the dynamic data, and cannot shield impact on business logics.

### SUMMARY

The disclosure is directed to a multi-language conversion device and a multi-language conversion method, which are adapted to automatically match a corresponding multi-language template according to a type of an application program interface requested by a webpage, and then effectively and dynamically convert a field to generate a converted field.

According to an embodiment of the disclosure, the multi-language conversion device of the disclosure includes a storage device and a processor. The storage device is configured to store a multi-language template configuration. The processor is coupled to the storage device and configured to receive a request instruction. The processor obtains aggregated data corresponding to the request instruction according to the request instruction. The processor performs type matching on a calling type and the multi-language template configuration according to the calling type of the request instruction, so as to obtain a corresponding multi-language template. The processor performs multi-language conversion on the aggregated data according to the multi-language template to obtain converted data.

According to an embodiment of the disclosure, the multi-language conversion method of the disclosure includes following steps: receiving a request instruction through a processor; obtaining aggregated data corresponding to the request instruction by the processor according to the request instruction; performing type matching on a calling type and a multi-language template configuration by the processor according to the calling type of the request instruction, so as to obtain a corresponding multi-language template; and performing multi-language conversion on the aggregated data by the processor according to the multi-language template to obtain converted data.

Based on the above descriptions, the multi-language conversion device and multi-language conversion method of the disclosure are adapted to automatically and dynamically convert data into a language type that conforms to the webpage according to the multi-language template, and match to a corresponding task logic.

To make the aforementioned more comprehensible, several embodiments accompanied with drawings are described in detail as follows.

### BRIEF DESCRIPTION OF THE DRAWINGS

FIG. 1 is a schematic circuit diagram of a multi-language conversion device according to an embodiment of the disclosure.

FIG. 2 is a flowchart of a multi-language conversion method according to an embodiment of the disclosure.

FIG. 3 is a schematic diagram of a multi-language conversion device and a computer device according to an embodiment of the disclosure.

FIG. 4 is a schematic execution diagram of a multi-language conversion device according to an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Firstly, a multi-language conversion device and a multi-language conversion method of the disclosure may respectively perform multi-language conversion on business data and dynamic data corresponding to an application program interface according to a multi-language template. Moreover, the business data may include non-source language data (such as item number), and the multi-language conversion device does not need to convert a language of the item number and directly sends it back to a terminal device, thereby simplifying a language conversion process. The business data and dynamic data described in the various embodiments of the disclosure are data called according to the application program interface, and the data may be, for example, material information, work order information, workshop information in manufacturing, bills in finance, or leave application form in a leave application process. Moreover, there are corresponding business logic scenarios for different types of application program interfaces, and the disclosure may correspondingly set different multi-language conversion templates for these business logic scenarios. In this way, reusability of the multi-language conversion process and configuration of aggregated data may be greatly improved, and appropriate converted data may be dynamically converted and displayed on the webpage according to data changes during application runtime.

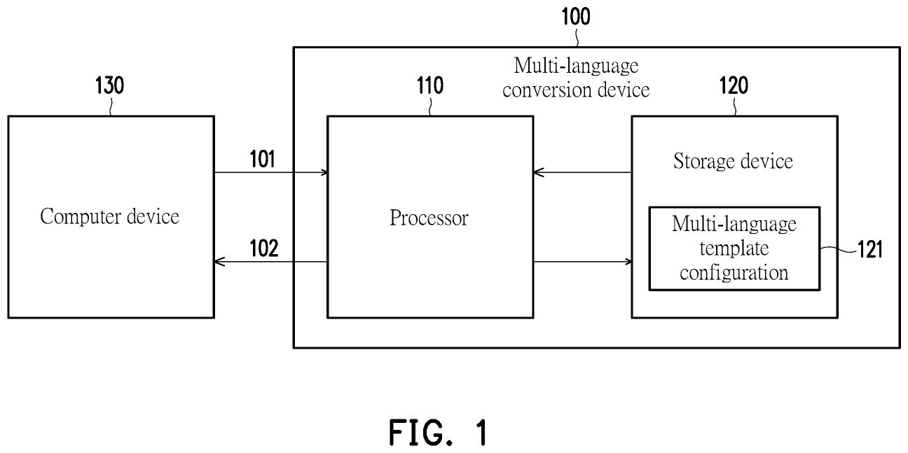

FIG. 1 is a schematic circuit diagram of a multi-language conversion device according to an embodiment of the disclosure. Referring to FIG. 1, a multi-language conversion device 100 includes a processor 110 and a storage device 120. The storage device 120 stores a multi-language template configuration 121. The processor 110 is coupled to the storage device 120. The multi-language conversion device 100 may also include an input device with actual circuit elements, a user interface, a communication interface, or a data transmission interface, etc., so that the processor 110 may receive an instruction or a signal matching a request from a data source or an external device or according to a user operation. In the embodiment, the multi-language conversion device 100 may be, for example, a server, a task management server, a personal computer, a workstation computer, or other electronic devices with data computing capabilities. In an embodiment, the multi-language conversion device 100 may also be integrated in a cloud server or a private server inside an enterprise. In an embodiment, the multi-language conversion device 100 may be used, for example, to implement an enterprise resource planning (ERP) system, and may execute multiple application programming interfaces (APIs) to obtain corresponding business data. In another embodiment, the multi-language conversion device 100 may be used, for example, to realize a function and structure of Software as a Service (SaaS).

In an embodiment, the multi-language template configuration 121 refers to multiple multi-language templates preset by a software designer according to multiple business scenarios. The business scenarios may be, for example, project card details, project milestone display, and historical project data information, etc., but the disclosure is not limited thereto. Moreover, the business scenarios may share one set of multi-language templates. Then, business logics (or programs) in each application program are also classified for corresponding to different multi-language templates, for example, if the application program includes a business scenario of project presentation, the application program corresponds to a multi-language template of project presentation. In other words, request instructions 101 are from outputs of a webpage, and each request instruction 101 corresponds to a different API. The multi-language conversion device 100 requests the API corresponding to the instruction, matches the corresponding multi-language template from the multi-language template configuration, and performs multi-language conversion on data according to the corresponding multi-language template.

In the embodiment, the processor 110 of the multi-language conversion device 100 may include, for example, a central processing unit (CPU), or other programmable general-purpose or special-purpose microprocessor, digital signal processor (DSP), application specific integrated circuits (ASIC), programmable logic device (PLD), other similar processing circuits or a combination of these devices.

In the embodiment, the storage device 120 may implement a remote cloud storage service or a local data storage service. The storage device 120 may include a memory and/or a database, where the memory may be, for example, a non-volatile memory (NVM). The storage device 120 may store related programs, modules, systems or algorithms for implementing various embodiments of the disclosure, so as to be accessed and executed by the processor 110 to realize the relevant functions and operations described in the various embodiments of the disclosure. The storage device 120 may also be used, for example, to cache structured and packaged data described in various embodiments of the disclosure.

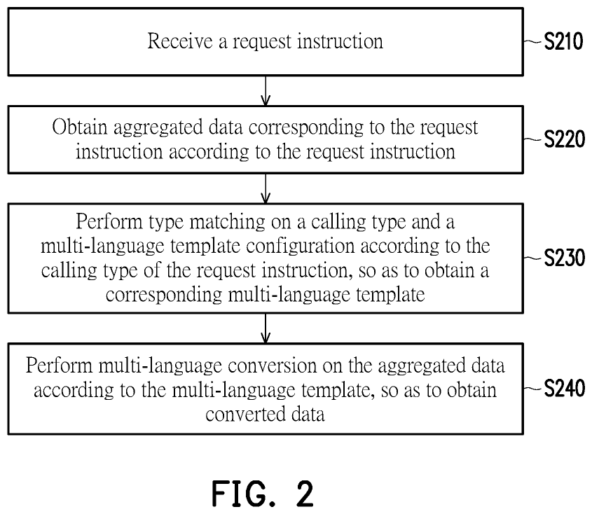

FIG. 2 is a flowchart of a multi-language conversion method according to an embodiment of the disclosure. Referring to FIG. 1 and FIG. 2, the multi-language conversion device 100 may perform the following steps S210-S240. In step S210, the processor 110 receives the request instruction 101. In the embodiment, the request instruction 101 may be a webpage browsing request instruction 101 or a hypertext transfer protocol (HTTP) request, so that a computer device 130 communicates with a server. For example, a user sends the request instruction 101 of an application program interface to the multi-language conversion device by operating the computer device 130, and the processor 110 receives the request instruction 101.

In step S220, the processor 110 obtains aggregated data corresponding to the request instruction 101 according to the request instruction 101. In an embodiment, the processor 110 obtains corresponding data from the storage device 120 according to the request instruction 101, and assembles multiple data as the aggregated data. In another embodiment, after the processing 110 obtains the data corresponding to the request instruction 101 from the storage device 120 according to the request instruction 101, when the processor 110 determines that the current data has deficiency (i.e., the data is incomplete), the processor 110 sends a request to a task engine to obtain business data information for application operation. Then, the processor 110 combines the business data information and the corresponding data in the storage device 120 to generate the aggregated data.

In step S230, the processor 110 matches a calling type with the multi-language template configuration 121 according to the calling type of the request instruction 101, so as to obtain a corresponding multi-language template. Specifically, the request instruction 101 is a request corresponding to an application program interface, and the calling type is a type of the application program interface. The multi-language template configuration 121 includes multiple multi-language templates, and each API type corresponds to one multi-language template. In this way, the processor 110 may match the multi-language template corresponding to the request instruction 101 from the multi-language template configuration 121 according to the calling type.

In step S240, the processor 110 performs multi-language conversion on the aggregated data according to the multi-language template corresponding to the request instruction 101 to obtain converted data 102. In an embodiment, the processor 110 performs language conversion on the aggregated data according to conversion rules in the multi-language template, so as to obtain the converted data 102 after field conversion in the aggregated data. In an embodiment, the multi-language template includes an original data type, a response data type, and a multi-language conversion field. The original data type may be, for example, a type corresponding to the aggregated data, and the response data type may be a type corresponding to target data, for example, the aggregated data includes a data type A, a data type B, a data type C, and a data type D, and the response data type is only the data type A and the data type B. Namely, the response data type is data that needs to be sent back to the webpage in the original data (i.e., aggregated data) corresponding to the request instruction 101. The multi-language conversion field is a name of the field that needs to perform multi-language conversion.

In another embodiment, the multi-language template includes an original data type path of query, a target data type path of response, and a name of field requiring multi-language conversion. In this way, the processor 110 may perform multi-language conversion on the data corresponding to the request instruction 101 according to the multi-language template, so as to obtain the converted field (i.e., the converted data 102).

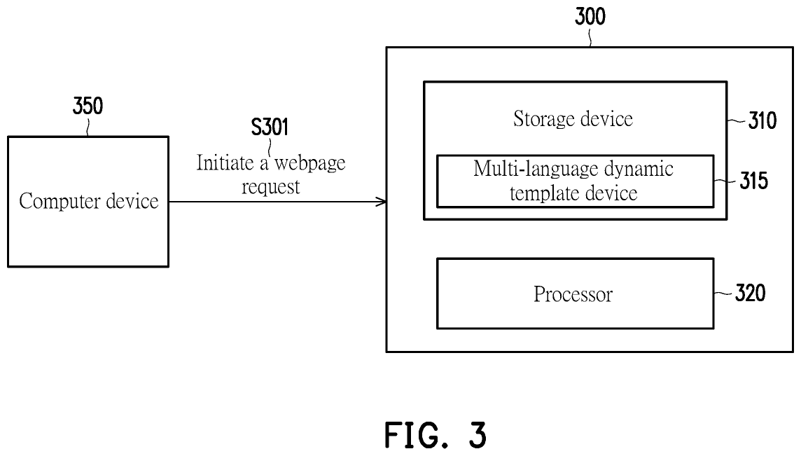

FIG. 3 is a schematic diagram of a multi-language conversion device and a computer device according to an embodiment of the disclosure. Referring to FIG. 2 and FIG. 3, in the embodiment, the storage device 310 may store a multi-language dynamic template device 315. In step S301, a terminal device initiates a webpage request to the multi-language conversion device 300. Specifically, the step of the processor 320 receiving the request instruction 101 includes: the terminal device (such as the computer device 350) outputs the request instruction 101 to the processor 320 through an API, and the processor 320 receives the request instruction 101. Moreover, the storage device 310 stores a multi-language dynamic template device 315.

It should be noted that the multi-language dynamic template device 315 includes multiple multi-language templates, and each multi-language template includes a conversion rule and multiple tag fields. The processor 320 performs multi-language conversion on the multiple tag fields in the aggregated data according to the multiple tag fields of the multi-language template and the conversion rule, so as to obtain the converted data 102.

In an embodiment, the processor 320 performs type matching according to semi-structured data and structured data in the aggregated data to obtain one or more corresponding multi-language templates. Namely, the processor 320 may respectively perform type matching on the semi-structured data (such as JSON data) and the structured data to obtain corresponding multi-language templates. Then, the processor 320 performs multi-language conversion on the data according to the multi-language templates, so as to realize more detailed and efficient data processing.

Finally, the processor 320 outputs the converted data 102 to the terminal device (such as the computer device 350) corresponding to the request instruction 101, and then displays the converted data 102 on a display of the terminal device.

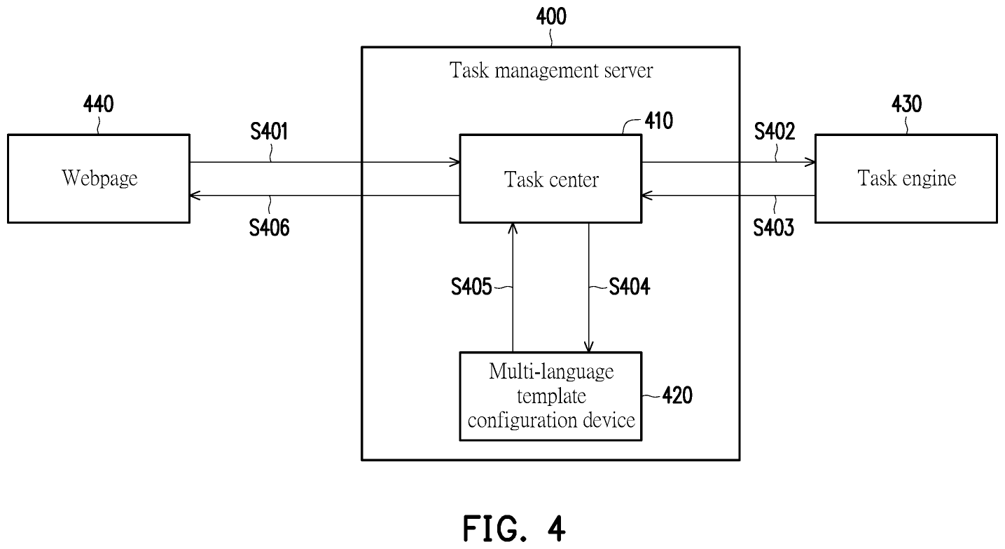

FIG. 4 is a schematic execution diagram of a multi-language conversion device according to an embodiment of the disclosure. Referring to FIG. 2 and FIG. 4, in the embodiment, the multi-language conversion device 300 is a task management server 400, the processor is a task center 410, and the storage device is a multi-language template configuration device 420. A task engine 430 is a server responsible for dynamically processing the application program, and is used to output dynamic data corresponding to the request instruction to the task center 410. The task management server 400 may execute following steps S401-S406. In step S401, a webpage 440 sends a request instruction to the task center 410. Then, in step S402, the task center 410 acquires business data from the storage device of the task management server 400 according to the request instruction, and sends a data request corresponding to the request instruction to the task engine 430.

In step S403, the task engine 430 returns corresponding dynamic data to the task center 410 according to the data request. The dynamic data may be, for example, data generated according to actual applications. Then, the task center 410 combines the business data and the dynamic data to generate the aggregated data.

In step S404, the task center 410 matches the calling type of the request instruction with the multi-language template configuration device 420, and then obtains a multi-language template corresponding to the calling type from multiple multi-language templates (step S405).

Specifically, the multi-language template configuring device 420 stores a look-up table and multiple multi-language templates. The look-up table shows a corresponding relationship between the type of the application program interface and the multi-language template, and the type of the application program interface is related to the type of business scenario.

On the other hand, the multi-language templates include an original data type, a converted data type, and multiple multi-language conversion fields. The multi-language conversion fields include fields that require language conversion and these fields respectively correspond to conversion fields in multiple languages. For example, a conversion field A in Chinese is “If” (corresponding to the conversion field A of Chinese), and English is “Project Center Console” (corresponding to the conversion field A of English). In this way, the task center 410 may obtain a converted data type from the corresponding multi-language template according to the data type in the aggregated data. Moreover, the task center 410 may perform multi-language conversion on the aggregated data according to the multi-language template, and then obtain the converted data corresponding to a current language of the webpage 440. The converted data is a field matching the multi-language conversion field in the aggregated data, and the task center 410 also performs language conversion according to the current language of the webpage 440.

Finally, in step S406, the task center 410 outputs the converted data corresponding to a display rule in the multi-language template to the web page 440, so that the converted data may be displayed on the display of the webpage 440.

Therefore, the multi-language conversion device 100 and the multi-language conversion method of the disclosure may call corresponding business data and dynamic data according to the request instruction, and encapsulate the business data and dynamic data into aggregated data, and then perform multi-language conversion according to the corresponding multi-language template, so as to efficiently obtain fields (i.e., converted data) that conform to the current language of the webpage 440.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents. Moreover, any embodiment of or the claims of the disclosure is unnecessary to implement all advantages or features disclosed by the disclosure. Moreover, the abstract and the name of the disclosure are only used to assist patent searching. Moreover, “first”, “second”, etc. mentioned in the specification and the claims are merely used to name the elements and should not be regarded as limiting the upper or lower bound of the number of the components/devices.

What is claimed is:

1. A multi-language conversion device, comprising:
a storage device, configured to store a multi-language template configuration; and
a processor, coupled to the storage device,
wherein the processor receives a request instruction and obtains aggregated data corresponding to the request instruction according to the request instruction,
wherein the processor performs type matching on a calling type and the multi-language template configuration according to the calling type of the request instruction, so as to obtain a multi-language template, which is corresponding to the calling type,
wherein the processor performs multi-language conversion on the aggregated data according to the multi-language template to obtain converted data.

2. The multi-language conversion device according to claim 1, wherein a terminal device outputs the request instruction to the processor through an application program interface, and the processor receives the request instruction,
wherein the processor outputs the converted data to the terminal device corresponding to the request instruction, and then displays the converted data on a display of the terminal device.

3. The multi-language conversion device according to claim 1, wherein the processor executes the multi-language conversion according to a language type of a current webpage, so as to convert the aggregated data into the converted data conforming to the language type.

4. The multi-language conversion device according to claim 1, wherein the multi-language template comprises a conversion rule and a plurality of tag fields,
wherein the processor performs the type matching according to semi-structured data and structured data in the aggregated data to obtain the multi-language template, which is corresponding to the semi-structured data and the structured data,
wherein the processor performs the multi-language conversion on the tag fields in the aggregated data according to the tag fields and the conversion rule of the multi-language template to obtain the converted data.

5. The multi-language conversion device according to claim 1, wherein the multi-language template comprises an original data type, a converted data type, and a plurality of multi-language conversion fields, wherein the multi-language template configuration comprises a plurality of multi-language templates.

6. The multi-language conversion device according to claim 5, wherein the processor obtains business data from the storage device according to the request instruction,
wherein the multi-language conversion device further comprises a task engine, and the task engine obtains dynamic data according to the request instruction,
wherein the processor performs an aggregation operation on the business data and the dynamic data to obtain the aggregated data.

7. The multi-language conversion device according to claim 1, wherein the calling type is a type of an application program interface,
wherein the processor matches the calling type of the request instruction with the multi-language template configuration, and then obtains the multi-language template corresponding to the calling type from a plurality of multi-language templates.

8. The multi-language conversion device according to claim 7, wherein the multi-language template configuration comprises a look-up table, wherein the look-up table shows a corresponding relationship between a type of the application program interface and the multi-language template, wherein the type of the application program interface is a business scenario type.

9. A multi-language conversion method, comprising:
receiving a request instruction by a processor;
obtaining aggregated data corresponding to the request instruction by the processor according to the request instruction;
performing type matching on a calling type and a multi-language template configuration by the processor according to the calling type of the request instruction, so as to obtain a multi-language template, which is corresponding to the calling type; and
performing multi-language conversion on the aggregated data by the processor according to the multi-language template, so as to obtain converted data.

10. The multi-language conversion method according to claim 9, wherein receiving the request instruction comprises:
outputting the request instruction to the processor by a terminal device through an application program interface, so that the processor receives the request instruction,
wherein after obtaining the converted data, the method further comprises:
outputting the converted data to the terminal device corresponding to the request instruction by the processor, so as to display the converted data on a display of the terminal device.

11. The multi-language conversion method according to claim 9, wherein obtaining the converted data comprises:
executing the multi-language conversion by the processor according to a language type of a current webpage, so as to convert the aggregated data into the converted data conforming to the language type.

12. The multi-language conversion method according to claim 9, wherein the multi-language template comprises a conversion rule and a plurality of tag fields,
wherein performing the multi-language conversion on the aggregated data to obtain the converted data comprises:
performing the type matching according to semi-structured data and structured data in the aggregated data by the processor to obtain the multi-language template, which is corresponding to the semi-structured data and the structured data; and
performing the multi-language conversion on the tag fields in the aggregated data by the processor according to the tag fields and the conversion rule of the multi-language template, so as to obtain the converted data.

13. The multi-language conversion method according to claim 9, wherein the multi-language template comprises an original data type, a converted data type, and a plurality of multi-language conversion fields, wherein the multi-language template configuration comprises a plurality of multi-language templates.

14. The multi-language conversion method according to claim 13, wherein obtaining the aggregated data corresponding to the request instruction comprises:
obtaining business data from a storage device by the processor according to the request instruction;
obtaining dynamic data by a task engine according to the request instruction,
performing an aggregation operation on the business data and the dynamic data by the processor to obtain the aggregated data.

15. The multi-language conversion method according to claim 14, wherein the calling type is a type of an application program interface,
wherein matching the calling type with the multi-language template configuration comprises:
matching the calling type of the request instruction with the multi-language template configuration by the processor, and obtaining the multi-language template corresponding to the calling type from a plurality of the multi-language templates.

16. The multi-language conversion method according to claim 15, wherein the multi-language template configuration comprises a look-up table, wherein the look-up table shows a corresponding relationship between a type of the application program interface and the multi-language template, wherein the type of the application program interface is a business scenario type.
